(19) United States
(12) Patent Application Publication
(10) Pub. No.: US 2024/0426744 A1
(43) Pub. Date: Dec. 26, 2024

(54) RUN-TIME CAVITY RING-DOWN SPECTROSCOPY PATTERN RECOGNITION

(71) Applicant: RingIR, Inc., Albuquerque, NM (US)

(72) Inventors: Charles Charbel Harb, Albuquerque, NM (US); Xavier Andrew Moya, Albuquerque, NM (US)

(21) Appl. No.: 18/341,416

(22) Filed: Jun. 26, 2023

(51) Int. Cl. G01N 21/31

(52) U.S. Cl. CPC G01N 21/31

(57) ABSTRACT

Systems and methods for run-time cavity ring-down spectroscopy pattern recognition. The method includes generating, with a sensor, a set of estimated ring-down data for an analyte. The method also includes generating a spectrum of the analyte based on the set of estimated ring-down data for the analyte. The method further includes generating a sample-invariant molecular fingerprint of the analyte based on the spectrum of the analyte. The method also includes determining one or more metrics between the sample-invariant molecular fingerprint of the analyte and predetermined molecular fingerprints of a plurality of reference samples. The method further includes identifying a match between the analyte and at least one of the plurality of reference samples based on the one or more metrics.

### BACKGROUND

Detecting infected patients is one important part of mitigating disease transmission during a pandemic. To this end, run-time cavity ring-down spectroscopy (rtCRDS) is one technique that, among other things, can be used to detect infected patients. For example, rtCRDS can be used for human breath analysis to diagnose SARS-COV-2 (i.e., COVID-19). rtCRDS estimates the changes in the rate of decay of a spectrum of pulsed light captured in an optical resonator containing an analyte and relates the change to the sample's absorption, producing a spectrum.

### SUMMARY

Analyzing an unknown sample with run-time cavity ring-down spectroscopy (rtCRDS) yields a cavity-enhanced linear absorption spectrum. Identifying an analyte in the unknown sample via rtCRDS requires conversion of the time-domain ring-down signal to a spectrum that can be matched to an entry in a data set of known compounds. Accordingly, the present disclosure provides systems and methods for rtCRDS pattern recognition that, among other things, convert a ring-down signal into a sample-invariant molecular fingerprint that can be matched to an entry in a data set of known compounds.

For example, the present disclosure provides a method for run-time cavity ring-down spectroscopy pattern recognition. The method includes generating, with a sensor, a set of estimated ring-down data for an analyte. The method also includes generating a spectrum of the analyte based on the set of estimated ring-down data for the analyte. The method further includes generating a sample-invariant molecular fingerprint of the analyte based on the spectrum of the analyte. The method also includes determining one or more metrics between the sample-invariant molecular fingerprint of the analyte and predetermined molecular fingerprints of a plurality of reference samples. The method further includes identifying a match between the analyte and at least one of the plurality of reference samples based on the one or more metrics.

The present disclosure also provides a system for run-time cavity ring-down spectroscopy pattern recognition comprising, in one implementation, a sensor and an analyte identifier. The sensor is configured to generate a set of estimated ring-down data for an analyte. The analyte identifier is configured to generate a spectrum of the analyte based on the set of estimated ring-down data for the analyte. The analyte identifier is also configured to generate a sample-invariant molecular fingerprint of the analyte based on the spectrum of the analyte. The analyte identifier is further configured to determine one or more metrics between the sample-invariant molecular fingerprint of the analyte and predetermined molecular fingerprints of a plurality of reference samples. The analyte identifier is also configured to identify a match between the analyte and at least one of the plurality of reference samples based on the one or more metrics.

The present disclosure further provides one or more tangible, non-transitory computer-readable mediums. The one or more tangible, non-transitory computer-readable mediums store instructions that when executed, cause one or more processing devices to generate a set of run-time estimated ring-down data for an analyte. The instructions also cause the one or more processing devices to generate a spectrum of the analyte based on the set of estimated ring-down data for the analyte. The instructions further cause the one or more processing devices to generate a sample-invariant molecular fingerprint of the analyte based on the spectrum of the analyte. The instructions also cause the one or more processing devices to determine one or more metrics between the sample-invariant molecular fingerprint of the analyte and predetermined molecular fingerprints of a plurality of reference samples. The instructions further cause the one or more processing devices to identify a match between the analyte and at least one of the plurality of reference samples based on the one or more metrics.

Other technical features may be readily apparent to one skilled in the art from the following figures, descriptions, and claims.

### BRIEF DESCRIPTION OF THE DRAWINGS

For a more complete understanding of the present disclosure and its advantages, reference is now made to the following description, taken in conjunction with the accompanying drawings. It is emphasized that, according to common practice, the various features of the drawings are not necessarily to-scale. On the contrary, the dimensions of the various features may be—and typically are—arbitrarily expanded or reduced for the purpose of clarity.

FIG. 1 is a block diagram of an example of a system for run-time cavity ring-down spectroscopy pattern recognition, in accordance with some implementations of the present disclosure.

FIG. 2 is a block diagram of an example of an analyte identifier included in the system of FIG. 1, in accordance with some implementations of the present disclosure.

FIG. 3 is a plot of an example of estimated ring-down data, in accordance with some implementations of the present disclosure.

FIG. 4 is a plot of an example of sample-invariant molecular fingerprints, in accordance with some implementations of the present disclosure.

FIG. 5 is a flow diagram of an example of a method for run-time cavity ring-down spectroscopy pattern recognition, in accordance with some implementations of the present disclosure.

FIGS. 6A-6E are plots of examples of Pearson correlation coefficients, in accord with some implementations of the present disclosure.

### NOTATION AND NOMENCLATURE

Various terms are used to refer to particular system components. A particular component may be referred to commercially or otherwise by different names. Further, a particular component (or the same or similar component) may be referred to commercially or otherwise by different names. Consistent with this, nothing in the present disclosure shall be deemed to distinguish between components that differ only in name but not in function. In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection, or through an indirect connection via other devices and connections.

The terminology used herein is for the purpose of describing particular example implementations only, and is not intended to be limiting. As used herein, the singular forms “a,” “an,” “the,” and “said” may be intended to include the plural forms as well, unless the context clearly indicates otherwise. The terms “a,” “an,” “the,” and “said” as used herein in connection with any type of processing component configured to perform various functions may refer to one processing component configured to perform each and every function, or a plurality of processing components collectively configured to perform each of the various functions. By way of example, “A processor” configured to perform actions A, B, and C may refer to one processor configured to perform actions A, B, and C. In addition, “A processor” configured to perform actions A, B, and C may also refer to a first processor configured to perform actions A and B, and a second processor configured to perform action C. Further, “A processor” configured to perform actions A, B, and C may also refer to a first processor configured to perform action A, a second processor configured to perform action B, and a third processor configured to perform action C. The method steps, processes, and operations described herein are not to be construed as necessarily requiring their performance in the particular order discussed or illustrated, unless specifically identified as an order of performance. It is also to be understood that additional or alternative steps may be employed.

The terms first, second, third, etc. may be used herein to describe various elements, components, regions, layers and/or sections; however, these elements, components, regions, layers and/or sections should not be limited by these terms. These terms may be only used to distinguish one element, component, region, layer, or section from another region, layer, or section. Terms such as “first,” “second,” and other numerical terms, when used herein, do not imply a sequence or order unless clearly indicated by the context. Thus, a first element, component, region, layer, or section discussed below could be termed a second element, component, region, layer, or section without departing from the teachings of the example implementations. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. In another example, the phrase “one or more” when used with a list of items means there may be one item or any suitable number of items exceeding one.

Spatially relative terms, such as “inner,” “outer,” “beneath,” “below,” “lower,” “above,” “up,” “upper,” “top,” “bottom,” “down,” “inside,” “outside,” “contained within,” “superimposing upon,” and the like, may be used herein. These spatially relative terms can be used for ease of description to describe one element's or feature's relationship to another element(s) or feature(s) as illustrated in the figures. The spatially relative terms may also be intended to encompass different orientations of the device in use, or operation, in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptions used herein interpreted accordingly.

“Run-time” may refer to less than or equal to one millisecond.

### DETAILED DESCRIPTION

The following discussion is directed to various implementations of the present disclosure Although one or more of these implementations may be preferred, the implementations disclosed should not be interpreted, or otherwise used, as limiting the scope of the present disclosure, including the claims. In addition, one skilled in the art will understand that the following description has broad application, and the discussion of any implementation is meant only to be exemplary of that implementation, and not intended to intimate that the scope of the disclosure, including the claims, is limited to that implementation.

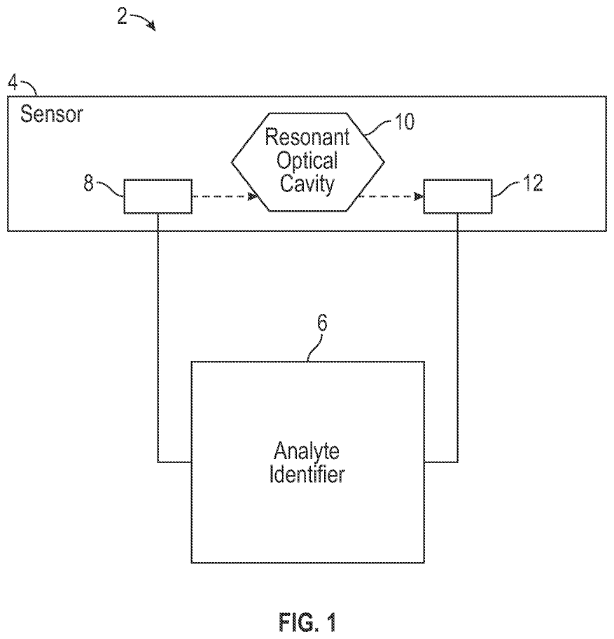

FIG. 1 is a block diagram of an example of a system 2 for run-time cavity ring-down spectroscopy (rtCRDS) pattern recognition. The system 2 illustrated in FIG. 1 includes a sensor 4 and an analyte identifier 6. The system 2 may include fewer, additional, or different components in different configurations than the system 2 illustrated in FIG. 1. For example, in some implementations, the system 2 may include multiple sensors. The sensor 4 illustrated in FIG. 1 (e.g., a spectrometer) includes a light emitter 8, a resonant optical cavity 10, and a light detector 12. A gas sample containing an analyte flows through the resonant optical cavity 10. In some implementations, the resonant optical cavity 10 is included in a closed pneumatic loop in which the gas sample is contained and pumped through the resonant optical cavity 10 at a controlled flow rate. The light emitter 8 emits light into the resonant optical cavity 10. For example, the light emitter 8 may include a quantum cascade laser (QCL) that emits mid-infrared light (e.g., between 6 microns and 12 microns). The light detector 12 detects the intensity of light within the resonant optical cavity 10. The light emitter 8 emits light in the form of short pulses. For each pulse, the light enters the resonant optical cavity 10 and constructively interferes with itself as it reflects thousands of times within the resonant optical cavity 10. The intensity of the pulse is amplified by constructive interference. After the input pulse from the light emitter 8 cuts off, the light at the output of the resonant optical cavity 10 to the light detector 12 begins to decay with a profile that can be approximated as a first-order dynamic system. The light intensity from the light detector 12 can determined using Equation 1 below.

$$V ( t ) = {V}_{o} \times - exp ( - t / τ ) \qquad ( Equation 1 )$$

where V (t) is the light intensity from the light detector 12 with respect to time t, Vₒ is the initial or max value of the light intensity, and t is the time constant of the response.

By setting t=τ, Equation 1 becomes Equation 2 below.

$$V ( τ ) = {V}_{o} \times - exp ( - 1 ) \qquad Equation 2$$

This allows the profile of the decay to be characterized by a single metric: the time constant, or the duration of time it takes for the light intensity to reach approximately 36.8% of the peak value.

The rate at which the light intensity decays is due to absorption at a particular wavelength by the gas sample (also referred to herein as an air sample) flowing through the resonant optical cavity 10. The composition of the gas sample flowing through the resonant optical cavity 10 can be determined by estimating the time constant of the decaying exponential along a spectrum of various wavelengths of light from the emitter. For example, the mole fractions (down to, e.g., the parts per trillion level) of the gas sample flowing through the resonant optical cavity 10 can be determined by creating a spectrum based on the estimated values of the time constant of the decaying exponential.

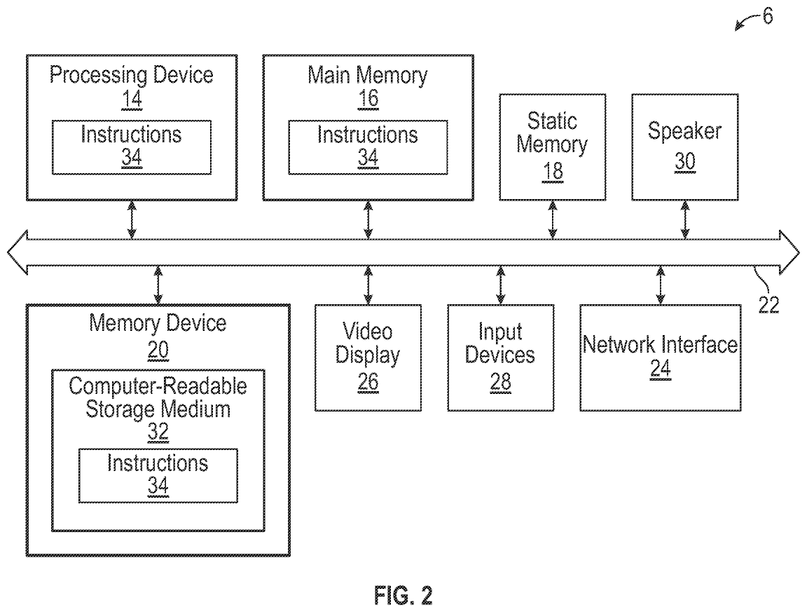

FIG. 2 is a block diagram of an example of the analyte identifier 6. In one example, the analyte identifier 6 may include a computing device. The analyte identifier 6 may be connected (e.g., networked) to other computer systems in a LAN, an intranet, an extranet, or the Internet, including via the cloud or a peer-to-peer network. The analyte identifier 6 may operate in the capacity of a server in a client-server network environment. The analyte identifier 6 may be a personal computer (PC), a tablet computer, a wearable (e.g., wristband), a set-top box (STB), a personal Digital Assistant (PDA), a mobile phone, a smartphone, a camera, a video camera, an Internet of Things (IoT) device, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The analyte identifier 6 (one example of a “computing device”) illustrated in FIG. 2 includes a processing device 14, a main memory 16 (e.g., read-only memory (ROM), flash memory, solid state drives (SSDs), dynamic random access memory (DRAM) such as synchronous DRAM (SDRAM)), a static memory 18 (e.g., flash memory, solid state drives (SSDs), static random access memory (SRAM)), and a memory device 20, which communicate with each other via a bus 22.

The processing device 14 represents one or more general-purpose processing devices such as a microprocessor, central processing unit, or the like. More particularly, the processing device 14 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 14 may also be one or more special-purpose processing devices such as an application specific integrated circuit (ASIC), a system on a chip, a field programmable gate array (FPGA), a digital signal processor (DSP), network processor, or the like. The processing device 14 may be configured to execute instructions for performing any of the operations and steps discussed herein.

The analyte identifier 6 illustrated in FIG. 2 further includes a network interface device 24. The analyte identifier 6 also may include a video display 26 (e.g., a liquid crystal display (LCD), a light-emitting diode (LED), an organic light-emitting diode (OLED), a quantum LED, a cathode ray tube (CRT), a shadow mask CRT, an aperture grille CRT, a monochrome CRT), input devices 28 (e.g., a keyboard and/or a mouse or a gaming-like control), and one or more speakers 30 (e.g., a speaker). In one illustrative example, the video display 26 and the input devices 28 may be combined into a single component or device (e.g., an LCD touch screen).

The memory device 20 may include a computer-readable storage medium 32 on which the instructions 34 embodying any one or more of the methods, operations, or functions described herein is stored. The instructions 34 may also reside, completely or at least partially, within the main memory 16 and/or within the processing device 14 during execution thereof by the analyte identifier 6. As such, the main memory 16 and the processing device 14 also constitute computer-readable media. The instructions 34 may further be transmitted or received over a network via the network interface device 24.

While the computer-readable storage medium 32 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium capable of storing, encoding or carrying out a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

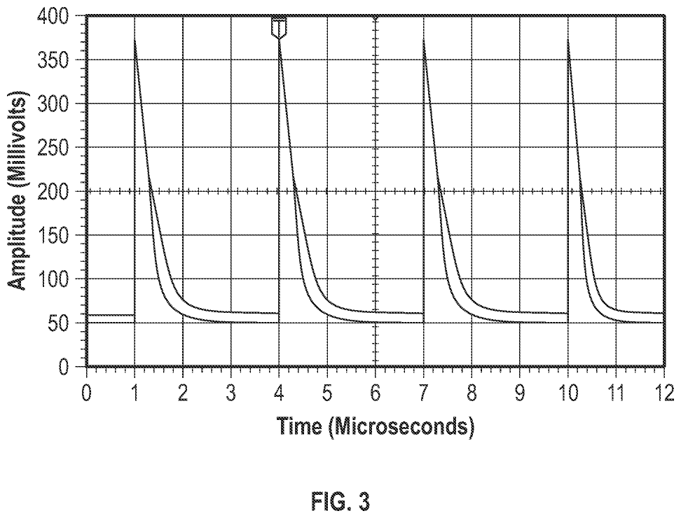

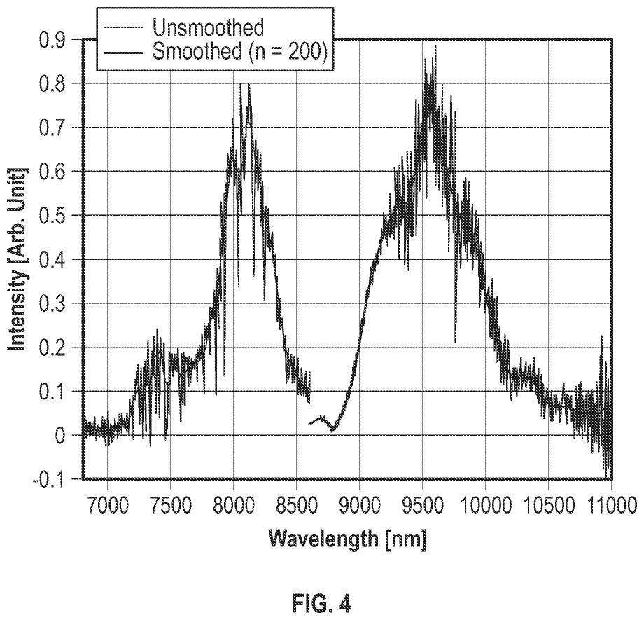

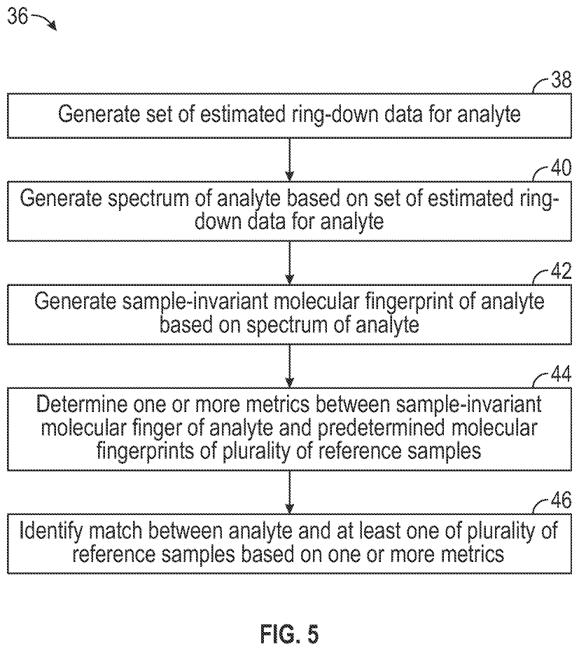

The ability to identify analytes in an unknown sample via rtCRDS relies on digital signal processing (DSP) powerful enough to accurately convert a time-domain, first-order, linear-time-invariant (LTI) ring-down signal, as shown in FIG. 3, into a sample-invariant molecular fingerprint, as shown in FIG. 4. A sample-invariant molecular fingerprint is a linear absorption curve over the wavelength range of the light emitter 8. This fingerprint can then be matched to an entry in a data set of known compounds. FIG. 5 is a flow diagram of an example of a method 36 for rtCRDS pattern recognition that includes, among other things, converting estimated ring-downs into a sample-invariant molecular fingerprint. The method 36 is performed by processing logic that may include hardware (circuitry, dedicated logic, etc.), software (such as is run on a general-purpose computer system, a dedicated machine, or a computing device of any kind (e.g., IoT node, wearable, smartphone, mobile device, etc.)), or a combination of both. The method 36 and/or each of its individual functions (including “methods,” as used in object-oriented programming), routines, subroutines, or operations may be performed by one or more processors of a computing device (e.g., any component of FIG. 1, such as the analyte identifier 6). In certain implementations, the method 36 may be performed by a single processing thread. Alternatively, the method 36 may be performed by two or more processing threads, wherein each thread implements one or more individual functions, routines, subroutines, or operations of the method 36.

For simplicity of explanation, the method 36 is depicted in FIG. 5 and described as a series of operations performed by the analyte identifier 6. However, operations in accordance with this disclosure can occur in various orders and/or concurrently, and/or with other operations not presented and described herein. For example, the operations depicted in the method 36 in FIG. 5 may occur in combination with any other operation of any other method disclosed herein. Furthermore, not all illustrated operations may be required to implement the method 36 in accordance with the disclosed subject matter. In addition, those skilled in the art will understand and appreciate that the method 36 could alternatively be represented via a state diagram or event diagram as a series of interrelated states.

At block 38, a set of estimated ring-down data for an analyte is generated. For example, the light emitter 8 (e.g., a QCL) may emit a pulse train into the resonant optical cavity 10. The pulse train produces numerous ring-downs (e.g., millions) as it scans across its operating wavelength range. The light detector 12 receives a response pulse train from the resonant optical cavity 10 and the sensor 4 generates the set of estimated ring-down data for the analyte based on the response pulse train. In some implementations, the sensor 4 utilizes QCLs to generate estimated ring-down data across a spectrum of light. At block 40, a spectrum of the analyte is generated based on the set of estimated ring-down data for the analyte. For example, the ring-down pulse train (included in the estimated ring-down data) is divided into a plurality of intervals (e.g., nearly instantaneous intervals) which are then converted into a ratio representing the relative signal power contained in each short time interval. These values can be plotted against their corresponding wavelength to generate the spectrum of the analyte. At block 42, a sample-invariant molecular fingerprint of the analyte is generated based on the spectrum of the analyte. In some implementations, the spectrum of the analyte is subtracted from a spectrum of the background gas (typically ambient air without the analyte) to generate the sample-invariant molecular fingerprint of the analyte.

At block 44, one or more metrics between the sample-invariant molecular fingerprint of the analyte and predetermined molecular fingerprints of a plurality of reference samples are determined. The plurality of reference samples may include fingerprints of several target chemicals that have been processed under controlled conditions. The plurality of reference samples can be stored in a database. For example, molecular fingerprints can be linked to metadata compiled from an open-source chemical database (e.g., PubChem or HITRAN). Identifying an unknown sample against a database of predetermined molecular fingerprints can include determining a metric between the sample data vector and potential matches. In some implementations, the one or more metrics include a minimized distance between the two vectors. For example, the analyte identifier 6 can determine a minimized distance between the two vectors to identify the closest match in the database, as described below in Equation 3. The distance can be found by:

$$min ( {d}_{x y} ) = min ( {\sum }_{i = 1}^{n} \vert {x}_{i} - {y}_{i} \vert ) \qquad Equation 3$$

where d_{xy} is the cumulative distance between vectors, and xᵢ and yᵢ are the ith element of each data vector (length=n).

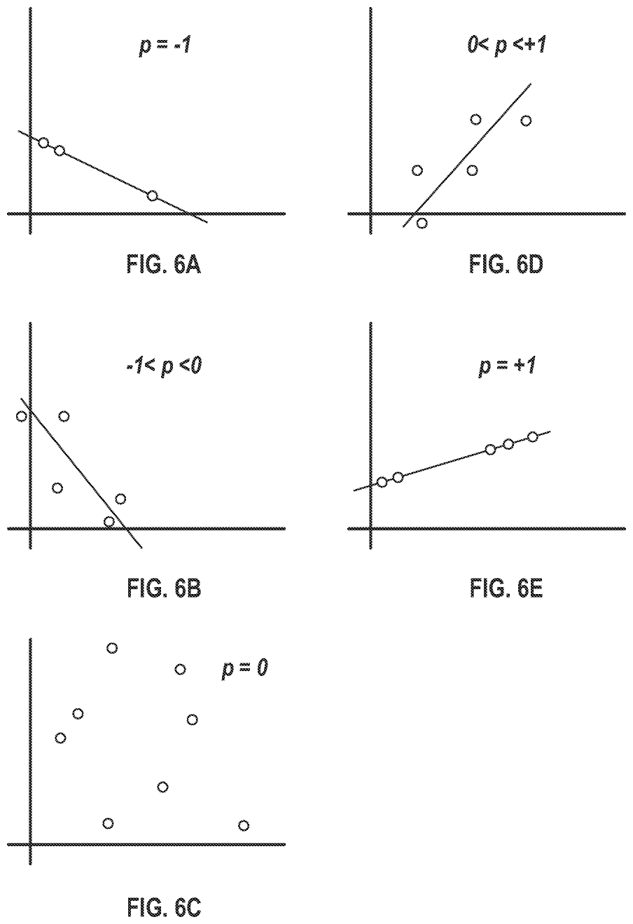

While the distance metric can be effective, it is can be highly dependent on sample concentration to find a match. Fingerprints with identical peak locations but different magnitudes might not be considered a match if the analyte concentrations vary between trials or if the system 2 operates with different levels of spectral power due to testing location or conditions. Thus, in some implementations, the one or more metrics include a Pearson Correlation Coefficient (PCC) as the discriminating criterion, as described below in Equation 4. A match can be determined by finding the maximum PCC between the unknown and database entries, calculated by:

$$max ( {r}_{x y} ) = max ( \frac{{\sum }_{i = 1}^{n} ( {x}_{i} - \overline{x} ) ( {y}_{i} - \overline{y} )}{\sqrt{{\sum }_{i = 1}^{n} {( {x}_{i} - \overline{x} )}^{2}} \sqrt{{\sum }_{i = 1}^{n} {( yi - \overline{y} )}^{2}}} ) \qquad Equation 4$$

Where r_{xy} is the PCC, xᵢ and yᵢ are the respective elements in the data vectors as described in Equation 3, and x̅ and y̅ are the respective mean values of the vectors. The PCC can include a metric on the interval [0, 1] describing the normalized covariance of x and y. Geometrically, it is a measure of the linear correlation of the vectors plotted as ordered pairs in [symbol] ² as shown in FIGS. 6A-6E. Two identical data sets or linearly correlated ones (even if one vector is scaled or offset) can produce a PCC of 1 and completely randomized vectors can produce a PCC of 0. Fingerprints from different samples of the same pure analyte will normally produce a PCC above 0.95, indicating near perfect correlation. Using PCC can find a match between samples of different concentrations, because the PCC is invariant to the scale and offset. Only the relative relationship between the peaks and valleys of the spectra (i.e., the shape) affect the correlation coefficients, not the absolute height of the peaks.

In some implementations, the sample-invariant molecular fingerprint of the analyte is filtered before the one or more metrics are determined at block 44. A common DSP filter is the moving average or boxcar, in which a window of fixed length moves along the spectrum, averaging each datum with its neighbors in the window, as shown in FIG. 4. While visually appealing, the moving average filter does not greatly improve the matching results, as this smoothing also risks destroying important analytical information in addition to noise. Too much smoothing will distort the amplitude and shape of even the largest absorption peaks.

In some implementations, the sample-invariant molecular fingerprint is filtered using a low-order median filter for, e.g., noise spike rejection. A median filter functions similarly to a moving average, except that the output for each datum is the median, not the mean, within the moving window. Low-order median filters correct erroneously light or dark pixels in image processing and work similarly on spectra in a single dimension. Sensitive rtCRDS measurements can include relatively large noise spikes which median filtering can mitigate without affecting the absorption signal.

Alternatively, or in addition, the sample-invariant molecular fingerprint is filtered using a multi-scan averaging filter to, e.g., improve the overall signal-to-noise ratio (SNR). Multi-scan averaging helps with overall noise rejection by combining scans taken in succession. By taking information from several measurements of the same sample, random noise in the data can be suppressed. Averaging scans cannot correct for persistent errors but, unlike a moving average filter, it will increase the SNR without smoothing over analytical data.

At block 46, a match is identified between the analyte and at least one of the plurality of reference samples based on the one or more metrics. For example, a match can be identified between the sample-invariant molecular fingerprint of the analyte and the references sample having a PCC closest in value to 1. In some implementations, the match between the analyte and at least one of the plurality of reference samples is further identified using one or more machine learning models. For example, the analyte identifier 6 may identify matches using machine learning models trained for K-nearest neighbor, Naive Bayes, random forest, neural networks, or a combination thereof. In some implementations, spectral data (e.g., spectra or molecular fingerprints) is calibrated, cleaned, normalized, and/or standardized prior to training and/or testing of the one or more machine learning models.

Consistent with the above disclosure, the examples of systems and methods enumerated in the following clauses are specifically contemplated and are intended as a non-limiting set of examples.

Clause 1. A method for run-time cavity ring-down spectroscopy pattern recognition, the method comprising:
generating, with a sensor, a set of estimated ring-down data for an analyte;
generating a spectrum of the analyte based on the set of estimated ring-down data for the analyte;
generating a sample-invariant molecular fingerprint of the analyte based on the spectrum of the analyte;
determining one or more metrics between the sample-invariant molecular fingerprint of the analyte and predetermined molecular fingerprints of a plurality of reference samples; and
identifying a match between the analyte and at least one of the plurality of reference samples based on the one or more metrics.

Clause 2. The method of any clause herein, wherein generating the sample-invariant molecular fingerprint of the analyte includes subtracting the spectrum of the analyte from a spectrum of a background gas.

Clause 3. The method of any clause herein, further comprising filtering the sample-invariant molecular fingerprint using a low-order median filter or a multi-scan averaging filter.

Clause 4. The method of any clause herein, wherein the one or more metrics including a Pearson correlation coefficient.

Clause 5. The method of any clause herein, wherein generating the spectrum of the analyte based on the set of estimated ring-down data for the analyte includes:
dividing the set of estimated ring-down data for the analyte into a plurality of intervals,
determining ratios representing relative signal power during each of the plurality of intervals, and
determining the spectrum of the analyte by comparing the ratios and corresponding wavelengths.

Clause 6. The method of any clause herein, wherein generating the set of estimated ring-down data for the analyte includes:
emitting a pulse train into an optical cavity including the analyte,
receiving a response pulse train from the optical cavity, and
generating the set of estimated ring-down data for the analyte based on the response pulse train.

Clause 7. The method of any clause herein, wherein the match between the analyte and the at least one of the plurality of reference samples is identifying using one or more machine learning models.

Clause 8. A system for run-time cavity ring-down spectroscopy pattern recognition, the system comprising:
a sensor configured to generate a set of estimated ring-down data for an analyte; and
an analyte identifier configured to:
generate a spectrum of the analyte based on the set of estimated ring-down data for the analyte,
generate a sample-invariant molecular fingerprint of the analyte based on the spectrum of the analyte,
determine one or more metrics between the sample-invariant molecular fingerprint of the analyte and predetermined molecular fingerprints of a plurality of reference samples, and
identify a match between the analyte and at least one of the plurality of reference samples based on the one or more metrics.

Clause 9. The system of any clause herein, wherein, to generate the sample-invariant molecular fingerprint of the analyte, the analyte identifier is further configured to subtract the spectrum of the analyte from a spectrum of a background gas.

Clause 10. The system of any clause herein, wherein the analyte identifier is further configured to filter the sample-invariant molecular fingerprint using a low-order median filter or a multi-scan averaging filter.

Clause 11. The system of any clause herein, wherein the one or more metrics including a Pearson correlation coefficient.

Clause 12. The system of any clause herein, wherein, to generate the spectrum of the analyte based on the set of estimated ring-down data for the analyte, the analyte identifier is further configured to:
divide the set of estimated ring-down data for the analyte into a plurality of intervals, determine ratios representing relative signal power during each of the plurality of intervals, and determine the spectrum of the analyte by comparing the ratios and corresponding wavelengths.

Clause 13. The system of any clause herein, wherein the sensor including:
an optical cavity including the analyte,
a light emitter configured to emit a pulse train into the optical cavity, and
a light detector configured to receive to a response pulse train from the optical cavity,
wherein, to generate the set of estimated ring-down data for the analyte, the sensor is further configured to generate the set of estimated ring-down data for the analyte based on the response pulse train.

Clause 14. The system of any clause herein, wherein the analyte identifier is further configured to identify the match between the analyte and the at least one of the plurality of reference samples using one or more machine learning models.

Clause 15. One or more tangible, non-transitory computer-readable mediums storing instructions that, when executed, cause one or more processing devices to:
generate a set of estimated ring-down data for an analyte;
generate a spectrum of the analyte based on the set of estimated ring-down data for the analyte;
generate a sample-invariant molecular fingerprint of the analyte based on the spectrum of the analyte;
determine one or more metrics between the sample-invariant molecular fingerprint of the analyte and predetermined molecular fingerprints of a plurality of reference samples; and
identify a match between the analyte and at least one of the plurality of reference samples based on the one or more metrics.

Clause 16. The one or more computer-readable mediums of any clause herein, wherein, to generate the sample-invariant molecular fingerprint of the analyte, the instructions further cause the one or more processing devices to subtract the spectrum of the analyte from a spectrum of a background gas.

Clause 17. The one or more computer-readable mediums of any clause herein, wherein the instructions further cause the one or more processing devices to filter the sample-invariant molecular fingerprint using a low-order median filter or a multi-scan averaging filter.

Clause 18. The computer-readable medium of any clause herein, wherein the one or more metrics including a Pearson correlation coefficient.

Clause 19. The one or more computer-readable mediums of any clause herein, wherein, to generate the spectrum of the analyte based on the set of estimated ring-down data for the analyte, the instructions further cause the one or more processing devices to:
divide the set of estimated ring-down data for the analyte into a plurality of intervals,
determine ratios representing relative signal power during each of the plurality of intervals, and
determine the spectrum of the analyte by comparing the ratios and corresponding wavelengths.

Clause 20. The one or more computer-readable mediums of any clause herein, wherein, to generate the set of estimated ring-down data for the analyte, the instructions further cause the one or more processing devices to:
emit a pulse train into an optical cavity including the analyte,
receive a response pulse train from the optical cavity, and
generate the set of estimated ring-down data for the analyte based on the response pulse train.

No part of the description in this application should be read as implying that any particular element, step, or function is an essential element that must be included in the claim scope. The scope of patented subject matter is defined only by the claims. Moreover, none of the claims is intended to invoke 25 U.S.C. § 104 (f) unless the exact words “means for” are followed by a participle.

The foregoing description, for purposes of explanation, use specific nomenclature to provide a thorough understanding of the described embodiments. However, it should be apparent to one skilled in the art that the specific details are not required to practice the described embodiments. Thus, the foregoing descriptions of specific embodiments are presented for purposes of illustration and description. They are not intended to be exhaustive or to limit the described embodiments to the precise forms disclosed. It should be apparent to one of ordinary skill in the art that many modifications and variations are possible in view of the above teachings.

The above discussion is meant to be illustrative of the principles and various embodiments of the present disclosure. Once the above disclosure is fully appreciated, numerous variations and modifications will become apparent to those skilled in the art. It is intended that the following claims be interpreted to embrace all such variations and modifications.

What is claimed is:

1. A method for run-time cavity ring-down spectroscopy pattern recognition, the method comprising:
generating, with a sensor, a set of estimated ring-down data for an analyte;
generating a spectrum of the analyte based on the set of estimated ring-down data for the analyte;
generating a sample-invariant molecular fingerprint of the analyte based on the spectrum of the analyte;
determining one or more metrics between the sample-invariant molecular fingerprint of the analyte and predetermined molecular fingerprints of a plurality of reference samples; and
identifying a match between the analyte and at least one of the plurality of reference samples based on the one or more metrics.

2. The method of claim 1, wherein generating the sample-invariant molecular fingerprint of the analyte includes subtracting the spectrum of the analyte from a spectrum of a background gas.

3. The method of claim 1, further comprising filtering the sample-invariant molecular fingerprint using a low-order median filter or a multi-scan averaging filter.

4. The method of claim 1, wherein the one or more metrics including a Pearson correlation coefficient.

5. The method of claim 1, wherein generating the spectrum of the analyte based on the set of estimated ring-down data for the analyte includes:
dividing the set of estimated ring-down data for the analyte into a plurality of intervals,
determining ratios representing relative signal power during each of the plurality of intervals, and
determining the spectrum of the analyte by comparing the ratios and corresponding wavelengths.

6. The method of claim 1, wherein generating the set of estimated ring-down data for the analyte includes:
emitting a pulse train into an optical cavity including the analyte,
receiving a response pulse train from the optical cavity, and
generating the set of estimated ring-down data for the analyte based on the response pulse train.

7. The method of claim 1, wherein the match between the analyte and the at least one of the plurality of reference samples is identifying using one or more machine learning models.

8. A system for run-time cavity ring-down spectroscopy pattern recognition, the system comprising:
a sensor configured to generate a set of estimated ring-down data for an analyte; and
an analyte identifier configured to:
generate a spectrum of the analyte based on the set of estimated ring-down data for the analyte,
generate a sample-invariant molecular fingerprint of the analyte based on the spectrum of the analyte,
determine one or more metrics between the sample-invariant molecular fingerprint of the analyte and predetermined molecular fingerprints of a plurality of reference samples, and
identify a match between the analyte and at least one of the plurality of reference samples based on the one or more metrics.

9. The system of claim 8, wherein, to generate the sample-invariant molecular fingerprint of the analyte, the analyte identifier is further configured to subtract the spectrum of the analyte from a spectrum of a background gas.

10. The system of claim 8, wherein the analyte identifier is further configured to filter the sample-invariant molecular fingerprint using a low-order median filter or a multi-scan averaging filter.

11. The system of claim 8, wherein the one or more metrics including a Pearson correlation coefficient.

12. The system of claim 8, wherein, to generate the spectrum of the analyte based on the set of estimated ring-down data for the analyte, the analyte identifier is further configured to:
divide the set of estimated ring-down data for the analyte into a plurality of intervals,
determine ratios representing relative signal power during each of the plurality of intervals, and
determine the spectrum of the analyte by comparing the ratios and corresponding wavelengths.

13. The system of claim 8, wherein the sensor including:
an optical cavity including the analyte,
a light emitter configured to emit a pulse train into the optical cavity, and
a light detector configured to receive to a response pulse train from the optical cavity,
wherein, to generate the set of estimated ring-down data for the analyte, the sensor is further configured to generate the set of estimated ring-down data for the analyte based on the response pulse train.

14. The system of claim 8, wherein the analyte identifier is further configured to identify the match between the analyte and the at least one of the plurality of reference samples using one or more machine learning models.

15. One or more tangible, non-transitory computer-readable mediums storing instructions that, when executed, cause one or more processing devices to:
generate a set of estimated ring-down data for an analyte;
generate a spectrum of the analyte based on the set of estimated ring-down data for the analyte;
generate a sample-invariant molecular fingerprint of the analyte based on the spectrum of the analyte;
determine one or more metrics between the sample-invariant molecular fingerprint of the analyte and predetermined molecular fingerprints of a plurality of reference samples; and
identify a match between the analyte and at least one of the plurality of reference samples based on the one or more metrics.

16. The one or more computer-readable mediums of claim 15, wherein, to generate the sample-invariant molecular fingerprint of the analyte, the instructions further cause the one or more processing devices to subtract the spectrum of the analyte from a spectrum of a background gas.

17. The one or more computer-readable mediums of claim 15, wherein the instructions further cause the one or more processing devices to filter the sample-invariant molecular fingerprint using a low-order median filter or a multi-scan averaging filter.

18. The one or more computer-readable mediums of claim 15, wherein the one or more metrics including a Pearson correlation coefficient.

19. The one or more computer-readable mediums of claim 15, wherein, to generate the spectrum of the analyte based on the set of estimated ring-down data for the analyte, the instructions further cause the one or more processing devices to:
divide the set of estimated ring-down data for the analyte into a plurality of intervals,
determine ratios representing relative signal power during each of the plurality of intervals, and
determine the spectrum of the analyte by comparing the ratios and corresponding wavelengths.

20. The one or more computer-readable mediums of claim 15, wherein, to generate the set of estimated ring-down data for the analyte, the instructions further cause the one or more processing devices to:
emit a pulse train into an optical cavity including the analyte,
receive a response pulse train from the optical cavity, and
generate the set of estimated ring-down data for the analyte based on the response pulse train.
